(19) United States
(12) Patent Application Publication
(10) Pub. No.: US 2005/0087538 A1
(43) Pub. Date: Apr. 28, 2005

(54) Iceless multiple can cooler

(76) Inventors: Darrell R. Wolfe, Warrensburg, NY (US); Rodney G. Wolfe, Pottersville, NY (US)

Correspondence Address: Richard C. Litman;LITMAN LAW OFFICES, LTD., P.O. Box 15035, Arlington, VA, 22215, US

(21) Appl. No.: 10/964,724

(22) Filed: Oct. 15, 2004

Related U.S. Application Data
(60) Provisional application No. 60/513,191, filed on Oct. 23, 2003.

(51) Int. Cl. F25D 1/00; F25D 3/08; A47J 39/00; A47J 41/00; B65D 81/38; B65D 83/72

(52) U.S. Cl. 220/592.16; 62/457.5; 220/592.25

(57) ABSTRACT

The iceless multiple can cooler is provided in the form of an elongated inner plastic tube closed at the bottom by a plastic disk. A seal is provided in the form of a removable plastic cap inserted into the upper opening of the tube. A gel filled ice pack in the shape of a twelve-ounce beverage can is inserted into the tube to further chill the cans. An elongated tube formed of a very dense closed cell plastic insulating foam material that is buoyant in water is adhered to the outer wall of the inner plastic. A disk of the foam material is provided inside the plastic cap and a disk of foam material is adhered to the bottom of both the inner plastic tube and the foam tube. A portion of the foam tube surrounds the top portion of the plastic cap. A tote bag is provided for transporting the cooler.

### CROSS-REFERENCE TO RELATED APPLICATION

This application claims the benefit of U.S. Provisional Patent Application Ser. No. 60/513,191, filed Oct. 23, 2003.

### BACKGROUND OF THE INVENTION

1. Field of the Invention

The present invention relates to portable tubular beverage coolers, and more particularly to a portable iceless multiple can cooler.

2. Description of the Related Art

Portable tubular beverage coolers are known in the prior art for their ease in handling, convenience in transport for outdoor activities and keeping bottled or canned beverages at a cool temperature for drinking. For example, U.S. Pat. No. 3,263,806 issued to Ring Aug. 2, 1966 teaches a tubular dispensing storage carrier for canned beverages having a tubular body of insulation made of expanded polystyrene beads. A hard and strong jacketing material such as cardboard, plastic or metal surrounds the relatively soft insulating tube. The end caps are formed of an insulation disk and a protective end cap of a hard material. A spring is provided within the storage carrier to dispense the bottles one at a time. Ring requires a strap over the end caps to prevent the spring from pushing the caps off the ends of the storage carrier.

In U.S. Pat. No. 4,516,409 issued May 14, 1985 to Hobbs, Jr. et al. a spring is also used as a dispensing mechanism. The tubular cooler of Hobbs, Jr. et al. is formed of connectable container sections. Each container section is formed with a chamber for a refrigerant such as propylene glycol. The container sections must be placed in a refrigerator to reduce the temperature of the refrigerant. While in U.S. Pat. No. 5,272,890 issued Dec. 28, 1993 to Penxa, the container sections are injection molded and the chambers are provided with a conventional refrigerant gel. However, Penxa requires a plurality of elongated flaccid member for receiving the beverage containers for manual insertion and withdrawal from the tubular container sections.

U.S. Pat. No. 4,577,474 issued Mar. 25, 1986 to Peterson teaches a thermally insulated tubular holder for a single beverage can. A thermally insulated holder is provided in the form of two identical mating halves comprised of closed cell foam of a resilient polymer such as neoprene. A refrigerant container is placed in the bottom of each half for cooling the beverage when the halves of the holder are placed over the can.

The U.S. Design Patent No. 302,775 issued Aug. 15, 1989 to Sinoff et al. teaches a tubular shaped beverage tote bag having end caps that are hinged to the main bag body and closed by zippers. A non-adjustable strap is provided for carrying the tote bag.

None of the above inventions and patents, taken either singly or in combination, is seen to describe the instant invention as claimed. Thus an iceless multiple can cooler solving the aforementioned problems is desired.

### SUMMARY OF THE INVENTION

The iceless multiple can cooler of the present invention is provided in the form of an elongated inner plastic tube having an inner diameter greater than the outer diameter of a twelve-ounce beverage can for easy insertion and removal of beverage cans. The tube is closed at the bottom by a plastic disk sealed by adhesive or other suitable means onto the bottom end of the tube. To seal the cans in the tube, a removable plastic cup shaped plug is inserted into the upper end of the tube. Six to seven cold beverage cans can be held within the inner plastic tube. Six cold cans may be inserted into the tube and be further chilled by a gel filled ice pack in the shape of a twelve-ounce beverage can. The ice pack is inserted within the plastic tube among the other cans. Insulation from the ambient temperature is provided in the form of a very dense closed cell plastic foam material that is buoyant in water. An elongated tube formed of the foam material is adhered by adhesive or other suitable means to the outer wall of the inner plastic tube. The foam tube is about two inches thick between inner and outer diameters. A two-inch thick disk of foam material is provide inside the plastic cup-shaped plug and a two inch thick disk of foam material is adhered to the bottom of the inner plastic tube and the bottom of the foam tube. A portion of the foam tube surrounds the top portion of the plastic plug. To transport the iceless multiple can cooler a tubular tote bag is provided. The tote bag includes an adjustable padded shoulder strap, a zippered storage pocket with a waterproof liner, and a hinged zippered access cover.

Accordingly, it is a principal object of the invention to provide an iceless multiple can cooler that conveniently chills six twelve-ounce cans of beverage.

It is another object of the invention to provide an iceless multiple can cooler that can float in water.

It is a further object of the invention to provide an iceless can cooler that is light weight an easy to carry by hikers, sports fans, boater, canoeists, bikers, cyclists, golfers, campers, contractors and the like.

Still another object of the invention is to provide an iceless multiple can cooler with a tote bag with a zippered pocket having a waterproof lining for carrying additional accessories.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of an iceless multiple can cooler according to the present invention.

FIG. 2 is a cross-sectional view of the iceless multiple can cooler according to the present invention.

FIG. 3 is an exploded view of the iceless multiple can cooler according to the present invention.

FIG. 4 is an enlarged perspective view of the end cap of the inner tube of the iceless multiple can cooler according to the present invention.

FIG. 5 is a perspective view of the tote bag for the iceless multiple can cooler according to the present invention.

Similar reference characters denote corresponding features consistently throughout the attached drawings.

### DETAILED DESCRIPTION OF THE PREFERRED EMBODIMENT

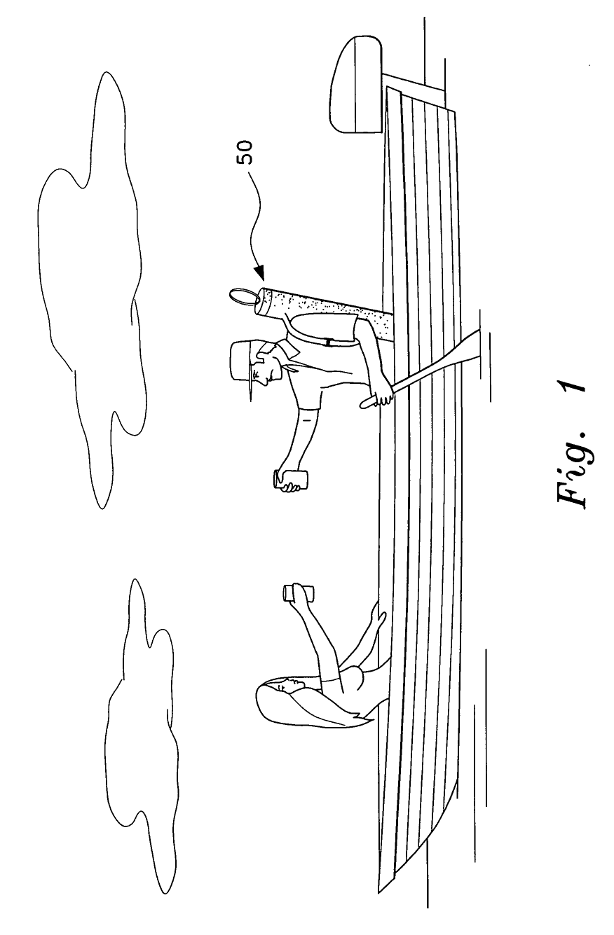

The present invention is an iceless multiple can cooler 50, which, referring to the drawing FIGS. 1-3, is provided in the form of an elongated, substantially rigid, inner plastic tube 51. The inner diameter of tube 51 selected to be greater than the outer diameter of a twelve-ounce beverage can for easy insertion and removal of the beverage cans. The tube 51 is closed at the bottom by a plastic disk 60 of the same material as tube 51. The disk 60 is sealed by adhesive or other suitable means onto the bottom end of the tube 51. The tube 51 and disk 60 are preferably formed of PVC.

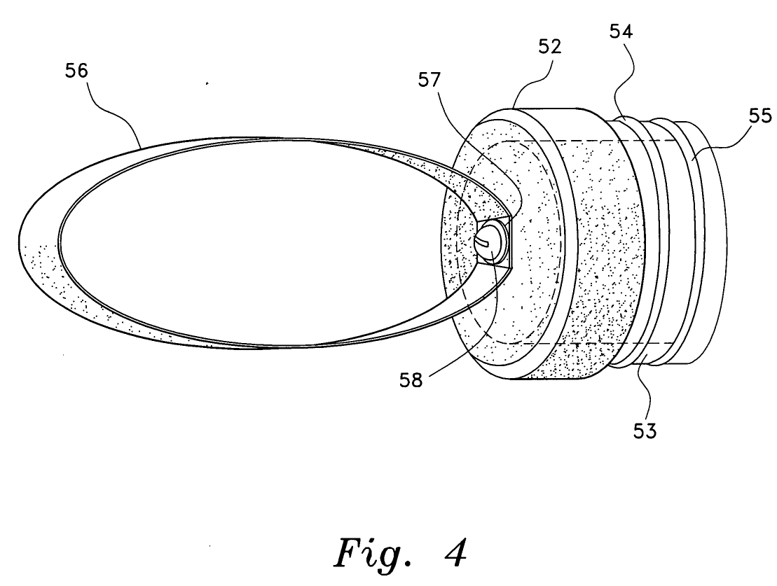

Six to seven cold cans 30 can be held within the inner plastic tube 51. To seal the cans 30 in the tube 51, a plastic end cap 52, preferably formed PVC is provided. As best seen in FIG. 4, cap 52 is cup-shaped and has a reduced outer diameter portion 53 that is frictionally received like a plug into the open upper end 61 of the tube 51. Rubber O-rings 54 and 55 are placed in grooves in the reduced outer diameter portion 53 of the cap 52 to ensure an airtight seal between cap 52 and the interior of tube 51.

A loop of any suitable material is secured to the cap 52 to form a strap 56 to aid in the removal of cap 52 from the tube 51. A screw 58 is passed through the hole of a washer 57, then through an aperture in the strap 56 and finally through an aperture in the center of the top of cap 52. A nut 58 inside the cap 52 is tightened onto the screw 58 to secure the strap 56 to cap 52.

The cold beverage cans 30 may be further chilled within tube 51 by a gel filled ice pack 31 provided in the shape of a twelve-ounce beverage can. When using the frozen ice pack 31, only six cold beverage cans 30 can be placed within tube 51. The ice pack 31 is inserted within the plastic tube 51 among the cans 30.

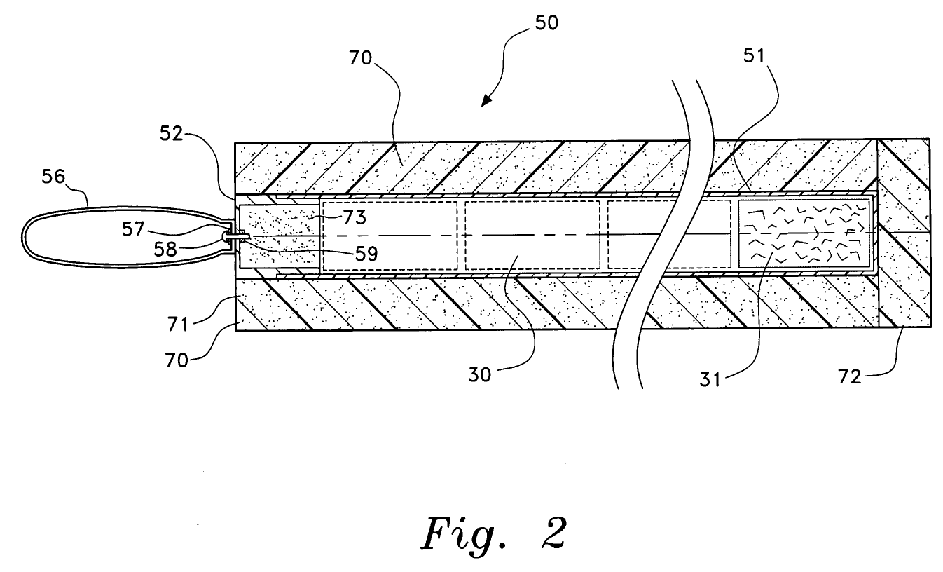

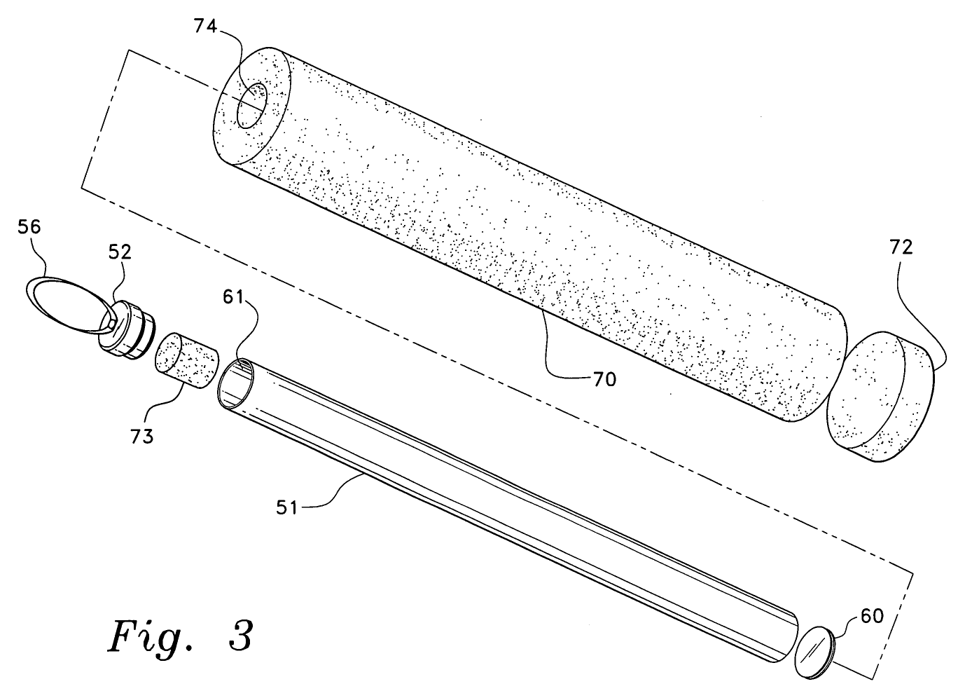

To insulate inner tube 51 and the cans 30 from the ambient temperature, insulation is provided in the form of a relatively firm, very dense closed cell plastic foam material that is buoyant in water. Referring to FIGS. 2 and 3, an elongated tube 70 formed of the foam material is adhered by adhesive or other suitable means, such as thermal welding to the outer wall of the inner plastic tube 51. The foam tube 70 is about two inches thick between inner and outer diameters. A two-inch thick disk 73 of foam material is adhered to the interior of plastic cap 52 and a two-inch thick disk 72 of foam material is adhered to the bottom of the inner plastic tube 51 and the bottom of the foam tube 70. An upper portion 74 of the foam tube 70 surrounds the widest portion of cap 52 when the reduced diameter portion of cap 52 is received within opening 61 of tube 51.

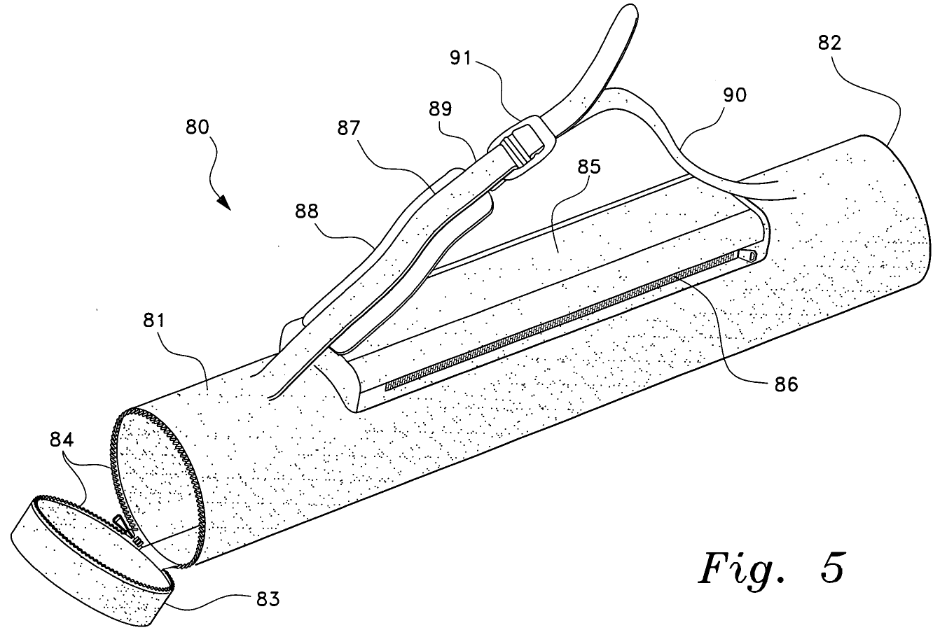

To transport the iceless multiple can cooler a cylindrical tote bag 80 is provided. See FIG. 5, where the tote bag 80 is shown to include an adjustable padded shoulder strap 87. Strap 87 is provided in the form of an upper strap portion 89 secured at one end to an upper portion of tote bag 80 and secured at a second end to a buckle 91 and a lower strap portion 90. A portion of upper strap portion 89 is padded at 88 for support upon the shoulders of a user carrying the cooler in tote bag 80. Lower strap portion 90 is attached adjacent the closed bottom 82 of the tote bag 80 and is adjustably attachable to buckle 91.

Tote bag 80 is also provided with a storage pocket 85 having a waterproof liner, a zipper 86 for closing storage pocket 85, and a hinged access cover 83 with a zipper 84 closing the top of tote bag 80.

It is to be understood that the present invention is not limited to the embodiment described above, but encompasses any and all embodiments within the scope of the following claims.

1. An iceless multiple can cooler, comprising:
an elongated substantially rigid plastic inner tube having an inner diameter slightly greater than the outer diameter of a twelve-ounce beverage can, said inner tube having an open upper end and being closed at a bottom end by a plastic disk sealed onto the bottom end of said inner tube;
a hollow cup-shaped plastic end cap provided with a reduced outer diameter portion that is frictionally received like a plug into the open upper end of said inner tube;
said end cap including O-rings placed in grooves in said reduced outer diameter portion of said end cap to ensure an airtight seal between said end cap and said inner tube;
said end cap further including handle means for assisting in the manual removal of said end cap from said tube; and
means for insulating said inner tube and end cap from ambient temperature adhered to said inner tube and end cap.

2. The iceless multiple can cooler according to claim 1, further comprising: means for transporting said cooler.

3. The iceless multiple can cooler according to claim 1, wherein said means for insulating said inner tube and said end cap comprises:
a thick inner disk of insulation material adhered to the interior of said end cap;
a thick outer tube of insulation material adhered to the exterior of said inner tube; and
a thick outer disk of insulation material adhered to a bottom end of said inner tube and said outer tube of insulation.

4. The iceless multiple can cooler according to claim 3, wherein said insulation material comprises a relatively firm, very dense closed cell plastic foam material that is buoyant in water.

5. The iceless multiple can cooler according to claim 3, wherein said insulation material of said disks and said outer tube is at least two inches in thickness.

6. The iceless multiple can cooler according to claim 1, wherein said handle means comprises a loop of any suitable material secured to a top portion of said end cap by a washer, a screw passing through said washer and said loop and a nut attached to said screw inside said end cap.

7. The multiple can cooler according to claim 2, wherein said means for transporting said cooler comprises a cylindrical tote bag formed from one of nylon and leather.

8. The multiple can cooler according to claim 7, wherein said tote bag includes:
an upper strap portion secured at one end to an upper portion of tote bag and secured at a second end to a buckle; and
a lower strap portion attached at one end to said tote bag adjacent the closed bottom of said tote bag and adjustably attachable to said buckle.

9. The multiple can cooler according to claim 8, wherein a portion of said upper strap portion is padded for support upon the shoulders of a user transporting the cooler in said tote bag.

10. The multiple can cooler according to claim 9, wherein said tote bag further includes a zippered storage pocket having a waterproof lining and a zippered access cover.

11. An iceless multiple can cooler, comprising:
an elongated substantially rigid plastic inner tube having an inner diameter slightly greater than the outer diameter of a twelve-ounce beverage can, said inner tube having an open upper end and being closed at a bottom end by a plastic disk sealed onto the bottom end of said inner tube;
a hollow cup-shaped plastic end cap provided with a reduced outer diameter portion that is frictionally received like a plug into the open upper end of said inner tube;
said end cap including O-rings placed in grooves in said reduced outer diameter portion of said end cap to ensure an airtight seal between said end cap and said inner tube;
said end cap further including handle means for assisting in the manual removal of said end cap from said tube;
means for insulating said inner tube and end cap from ambient temperature adhered to said inner tube and end cap;
means for transporting said cooler; wherein
said means for insulating said inner tube and said end cap comprises:
a thick inner disk of insulation material adhered to the interior of said end cap;
a thick outer tube of insulation material adhered to the exterior of said inner tube; and
a thick outer disk of insulation material adhered to a bottom end of said inner tube and said outer tube of insulation.

12. The multiple can cooler according to claim 11, wherein said insulation material comprises a relatively firm, very dense closed cell plastic foam material that is buoyant in water.

13. The multiple can cooler according to claim 12, wherein said insulation material of said disks and said outer tube is at least two inches in thickness.

14. The multiple can cooler according to claim 13, wherein said insulation material of said disks and said outer tube is at least two inches in thickness.

15. The multiple can cooler according to claim 14, wherein said means for transporting said cooler comprises a cylindrical tote bag formed from one of nylon and leather.

16. The multiple can cooler according to claim 15, wherein said tote bag includes:
an upper strap portion secured at one end to an upper portion of tote bag and secured at a second end to a buckle; and
a lower strap portion attached at one end to said tote bag adjacent the closed bottom of said tote bag and adjustably attachable to said buckle.

17. The multiple can cooler according to claim 16, wherein a portion of said upper strap portion is padded for support upon the shoulders of a user transporting the cooler in said tote bag.

18. The multiple can cooler according to claim 17, wherein said tote bag further includes a zippered storage pocket having a waterproof lining and a zippered access cover.

19. A multiple can cooler comprising:
an elongated substantially rigid plastic inner tube having an inner diameter slightly greater than the outer diameter of a twelve-ounce beverage can, said inner tube having an open upper end and being closed at a bottom end by a plastic disk sealed onto the bottom end of said inner tube;
a hollow cup-shaped plastic end cap provided with a reduced outer diameter portion that is frictionally received like a plug into the open upper end of said inner tube;
said end cap including O-rings placed in grooves in said reduced outer diameter portion of said end cap to ensure an airtight seal between said end cap and said inner tube;
said end cap further including handle means for assisting in the manual removal of said end cap from said tube;
a thick inner disk of insulation material adhered to the interior of said end cap;
a thick outer tube of insulation material adhered to the exterior of said inner tube; and
a thick outer disk of insulation material adhered to a bottom end of said inner tube and said outer tube of insulation, wherein
said disks and said outer tube is at least two inches in thickness and said insulation material comprises a relatively firm, very dense closed cell plastic foam material that is buoyant in water.

20. The iceless multiple can cooler according to claim 19, wherein said handle means comprises a loop of any suitable material secured to a top portion of said end cap by a washer, a screw passing through said washer and said loop and a nut attached to said screw inside said end cap.
